(19) United States
(12) Patent Application Publication
(10) Pub. No.: US 2008/0125961 A1
(43) Pub. Date: May 29, 2008

(54) Method of converting mode of user interface of mobile terminal

(75) Inventor: Dok Shin Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/871,641

(22) Filed: Oct. 12, 2007

(30) Foreign Application Priority Data
Nov. 23, 2006 (KR) 2006-0116287

(51) Int. Cl. G01C 21/00

(52) U.S. Cl. 701/200

(57) ABSTRACT

A method of converting a mode of a user interface in a mobile terminal. The method of converting a mode of a user interface of a mobile terminal having a 4-way navigation key includes determining whether a corner direction press signal of the 4-way navigation key is input in a 4-way navigation key mode; and converting the 4-way navigation key mode to an 8-way pointer mode when a corner direction press signal of the 4-way navigation key is input in a 4-way navigation key mode. Therefore, in a user interface of a mobile terminal, both a 4-way navigation key mode and an 8-way pointer mode can be used, and mode conversion can be simply performed.

### PRIORITY

This application claims priority to an application filed in the Korean Intellectual Property Office on Nov. 23, 2006 and assigned Serial No. 2006-0116287, the contents of which are incorporated herein by reference.

### BACKGROUND OF THE INVENTION

1. Field of the Invention

The present invention relates to a user interface of a mobile terminal, and more particularly, to a method of converting a mode of a user interface between a 4-way navigation key mode and an 8-way pointer mode in a mobile terminal.

2. Description of the Related Art

Due to development of telecommunication technology and semiconductor technology, various mobile terminals are now in use. A mobile terminal that has been generally used as a mobile phone has, for example, now developed into a personal information terminal, such as a Personal Digital Assistant (PDA), a mobile broadcasting receiver, such as a Digital Multimedia Broadcasting (DMB) receiver, a multimedia player, such as a Moving Pictures Experts Group Layer 3 (MP3) player, a Portable Multimedia Player (PMP), etc., as well as other various device configurations.

Nowadays, mobile terminals execute mobile convergence having functions of other terminals as well as their intrinsic functions.

In general, a user interface of a mobile terminal is moved in four directions of a horizontal axis and a vertical axis. That is, when selecting a specific item or entering a specific menu through a screen of a display unit of the mobile terminal, the user moves a focus on a screen of a display unit in a horizontal direction and a vertical direction by manipulating a 4-way navigation key. This moving method is commonly referred to as a 4-way navigation key mode. Because a 4-way navigation key mode has a limited moving direction, the 4-way navigation key mode is inconvenient to use and has a limitation in intuitive recognition of direction.

FIGS. 1A and 1B show a 4-way navigation key mode of a conventional user interface. In FIG. 1A, items 11, which are objects for selection, are disposed in a lattice form. In consideration of movement in four directions, items, such as a file list, content list, special symbols, or the like, are disposed on a screen of the display unit in a lattice form.

In order to move a focus 13 positioned at an item 11a at an upper left side of the screen to an item 11b at a lower right side, whichever movement path a user selects (for example, path 14a or 14b), the user should press down each of a right key 15a and a down key 15b of the 4-way navigation key 15 at least once. Whenever an item at a target position is positioned in a diagonal direction from an item 11a at which the focus 13 is positioned, because the focus 13 can be moved in only four directions, and therefore cannot move in a diagonal direction, the user should press the 4-way navigation key 15 multiple times. Accordingly, when manipulating the 4-way navigation key 15 in the user interface of FIG. 1A, a user may feel discomfort and cannot effectively use the user interface.

In FIG. 1B, items 12, which are objects for selection, are disposed in a non-lattice form. For example, a menu icon on ‘my screen’ (a screen in a standby state that can be freely edited by the user) and a linker in a web page can be disposed in a non-lattice form. In this case, even if the 4-way navigation key 15 is pressed down once, the focus 13 directly moves to the target item. However, because a disposition of the items 12 and the 4-way navigation key 15 do not intuitively relate to each other, the user may be confused in determining a moving path. For example, in order to move the focus 13 positioned at an item 12a at an upper side of the screen to the item 12b at a lower right side, the user may be confused in determining whether a right key 15a or a down key 15b of the 4-way navigation key 15 should be pressed.

Due to these disadvantages, research for a user interface for moving in four or more directions has been actively performed. A typical research subject is a so-called 8-way pointer mode. An 8-way pointer mode supports movement in an upper left direction, upper right direction, lower left direction, and lower right direction in addition to the upward, downward, left, and right directions. However, a conventional research result about an 8-way pointer mode is to completely replace a 4-way navigation key mode of a user interface with an 8-way pointer mode.

Accordingly, an 8-way pointer mode may be inconvenient for a user accustomed to an existing 4-way navigation key mode. Further, situations that may be generated in a mobile terminal do not always need an 8-way pointer mode. In particular, because a hotkey function is generally mapped to a 4-way navigation key, it is more preferable to have an advantage of an 8-way pointer mode while sustaining an existing key mapping paradigm.

Accordingly, it is preferable to use both a 4-way navigation key mode and an 8-way pointer mode rather than to completely replace a 4-way navigation key mode with an 8-way pointer mode. In order to use two modes together, a need exists for a method of converting two modes.

### SUMMARY OF THE INVENTION

The present invention substantially solves the above problems and provides at least the advantages below. The present invention provides a method of converting a mode of a user interface in a mobile terminal, that can simply convert a mode of the user interface in order to use both a 4-way navigation key mode and an 8-way pointer mode.

The present invention further provides a method of converting a mode of a user interface in a mobile terminal that can logically and intuitively correspond to using an 8-way pointer mode when converting a 4-way navigation key mode to the 8-way pointer mode in the user interface of the mobile terminal.

The present invention further provides a method of converting a mode of a user interface in a mobile terminal that can convert a mode of the user interface without adding a separate key in a mobile terminal.

The present invention further provides a method of converting a mode of a user interface in a mobile terminal that can effectively use the user interface of the mobile terminal.

In accordance with an aspect of the present invention, a method of converting a mode of a user interface of a mobile terminal having a 4-way navigation key includes determining whether a corner direction press signal of the 4-way navigation key is input in a 4-way navigation key mode; and converting the 4-way navigation key mode to an 8-way pointer mode when a corner direction press signal of the 4-way navigation key is input in a 4-way navigation key mode.

The method may further include determining whether a press signal of a mode cancellation key is input after converting the 4-way navigation key mode to the 8-way pointer mode; and converting the 8-way pointer mode to the 4-way navigation key mode when a press signal of a mode cancellation key is input.

The method may further include determining whether a press signal of the 4-way navigation key is input within a preset time duration after converting the 4-way navigation key mode to the 8-way pointer mode when a press signal of a mode cancellation key is not input; and converting, the 8-way pointer mode to the 4-way navigation key mode when a press signal of the 4-way navigation key is not input within a preset time duration.

The method may further include determining whether a press signal of the 4-way navigation key is input within a preset time duration after converting the 4-way navigation key mode to the 8-way pointer mode; and converting the 8-way pointer mode to the 4-way navigation key mode when a press signal of the 4-way navigation key is not input within a preset time duration.

In accordance with another aspect of the present invention, a method of converting a mode of a user interface of a mobile terminal having a 4-way navigation key in which a press detection sensor is provided in each of an upward direction, downward direction, left direction, and right direction includes determining whether a press signal is input to each of two adjacent press detection sensors within a first preset time duration in a 4-way navigation key mode; and converting the 4-way navigation key mode to an 8-way pointer mode when a press signal is input to each of two adjacent press detection sensors within a first preset time duration.

The method may further include determining whether a press signal of a mode cancellation key is input after converting the 4-way navigation key mode to the 8-way pointer mode; and converting the 8-way pointer mode to the 4-way navigation key mode when a press signal of a mode cancellation key is input.

The method may further include determining whether a press signal is input to the press detection sensor within a second preset time duration after converting the 4-way navigation key mode to the 8-way pointer mode when a press signal of a mode cancellation key is not input; and converting the 8-way pointer mode to the 4-way navigation key mode when a press signal is not input to any of the press detection sensors within a second preset time duration.

The method may further include determining whether a press signal is input to any of the press detection sensors within a second preset time duration after converting the 4-way navigation key mode to the 8-way pointer mode; and converting the 8-way pointer mode to the 4-way navigation key mode when a press signal is not input to any of the press detection sensors within a second preset time duration.

Converting the 4-way navigation key mode to an 8-way pointer mode may include activating a pointer for moving in eight directions.

Converting the 8-way pointer mode to the 4-way navigation key mode may include inactivating a pointer for moving in eight directions.

### BRIEF DESCRIPTION OF THE DRAWINGS

The objects, features and advantages of the present invention will be more apparent from the following detailed description in conjunction with the accompanying drawings, in which:

FIGS. 1A and 1B are diagrams illustrating a 4-way navigation key mode of a conventional user interface;

FIGS. 2A to 2D are diagrams illustrating a method of converting a mode of a user interface according to the present invention;

FIG. 3 is a diagram illustrating a modified 4-way navigation key for using in a method of converting a mode according to the present invention;

FIG. 4 is a block diagram illustrating a configuration of a mobile terminal for performing a method of converting a mode according to the present invention;

FIG. 5 is a flowchart illustrating a method of converting a mode of a user interface according to the present invention; and

FIG. 6 is a flowchart illustrating in detail a step of identifying an input of a search key press signal of the method of FIG. 5.

### DETAILED DESCRIPTION OF THE PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

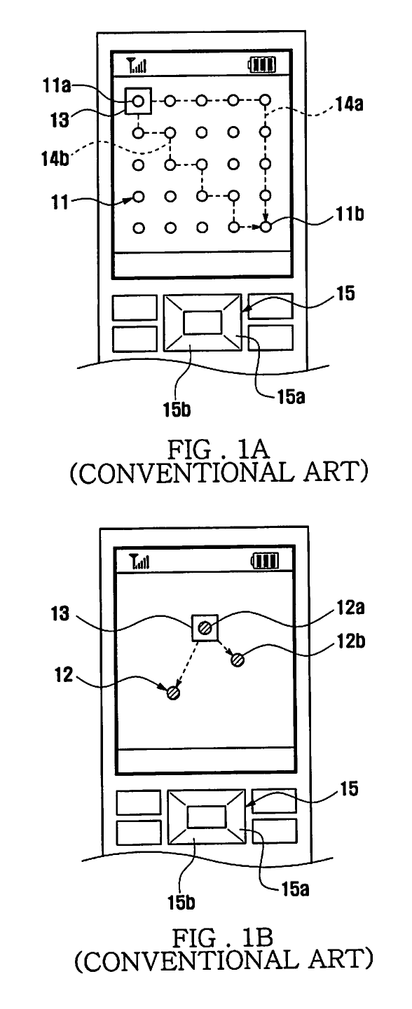

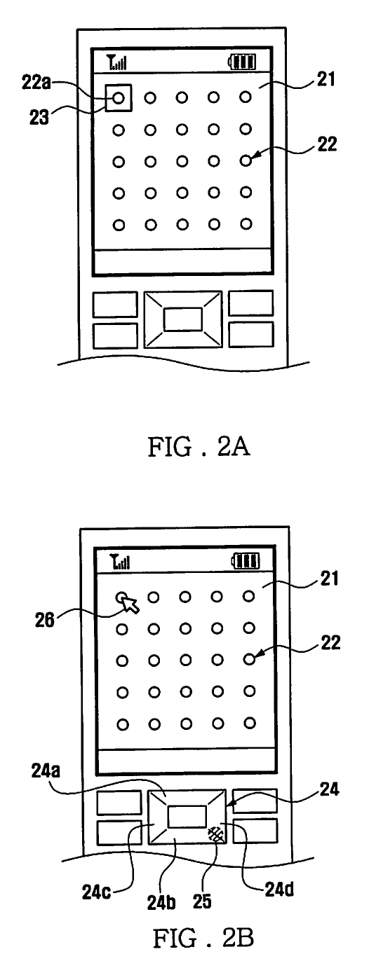

FIGS. 2A to 2D show a method of converting a mode of a user interface according to the present invention. FIGS. 2A to 2D show a case in which items 22 are disposed in a lattice form on a screen 21 of a display unit. However, the method of converting a mode of a user interface according to the present invention is not limited thereto and can be applied to a case where items are disposed in a non-lattice form, as shown in FIG. 1B.

FIG. 2A shows a case in which a user interface of a mobile terminal is in a 4-way navigation key mode. A focus 23 and the items 22 disposed in a lattice form are displayed on the screen 21 of the display unit. The items 22 displayed on the screen 21 may be, for example, a file list, a content list, special symbols, or the like. The focus 23 is sometimes referred to as a highlight or a cursor, and a form of the focus 23 changes according to the displayed items 22. The focus 23 is positioned at an item 22a of the items 22 displayed on the screen 21.

FIG. 2B shows a case in which the user interface is in an 8-way pointer mode. In order to convert a mode of the user interface from the 4-way navigation key mode shown in FIG. 2A to the 8-way pointer mode shown in FIG. 2B, any corner 25 of the 4-way navigation key 24 is pressed, as shown in FIG. 2B.

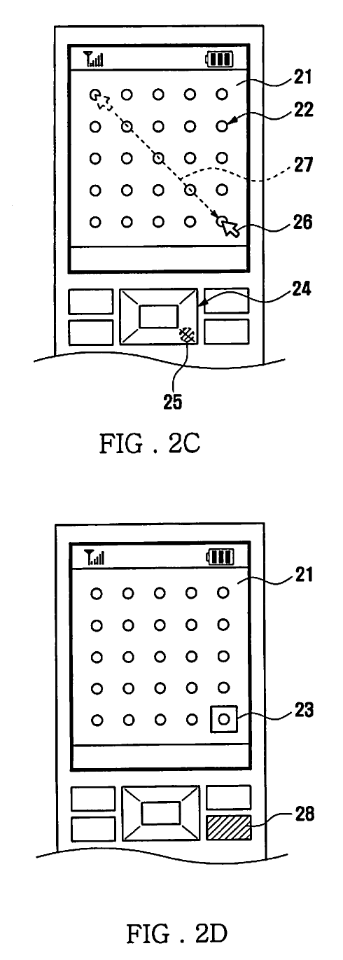

The 4-way navigation key 24 includes four keys comprising an upper key 24a, lower key 24b, left key 24c, and right key 24d. Border portions between any two adjacent keys in the 4-way navigation key 24, i.e. an upper left portion, upper right portion, lower left portion, and lower right portion, are defined as the corners 25 because the 4-way navigation key 24 generally has a quadrangular shape, and the borders of two keys correspond to corners of a quadrangle. However, as shown in FIG. 3, which illustrates a modified 4-way navigation key for using in a method of converting a mode, because the 4-way navigation key 24 can have various forms, an upper left portion, upper right portion, lower left portion, and lower right portion of the 4-way navigation key 24 are referred to as the corner 25, regardless of a form of the 4-way navigation key 24.

Referring again to FIGS. 2A and 2B, if a user presses the corner 25 of the 4-way navigation key 24 in the 4-way navigation key mode, the 4-way navigation key mode is converted to the 8-way pointer mode. The focus 23 disappears and a pointer 26 appears on the screen 21 of the display unit at the same position as the focus 23. The focus 23 used in the 4-way navigation key mode can be used in the 8-way pointer mode. However, in order to visibly display mode conversion, the pointer 26 is preferably used in the 8-way pointer mode.

FIG. 2C shows movement of the pointer 26 in the 8-way pointer mode. If the user again presses the corner 25 of the 4-way navigation key 24 after a mode is converted, the pointer 26 moves on the screen 21 of the display unit in a direction corresponding to the corner 25. A moving path 27 of the pointer 26 is in a diagonal direction. Compared with the case of FIG. 1A, the moving path 27 of FIG. 2C is shorter, and a key manipulation by the user is much simpler.

Pressing the corner 25, as shown in FIG. 2B, converts a mode, and pressing the corner 25 again, as shown in FIG. 2C, moves the pointer 26. In order to convert a mode, any corner 25 of the 4-way navigation key 24 can be pressed. However, because mode conversion is generally a preliminary operation before moving a pointer, the same corner 25 is continuously pressed without releasing finger pressure. In other words, when the corner 25 of a direction in which to move the pointer 26 is continuously pressed, both mode conversion and pointer movement are performed, so that a user interface can be logically and intuitively embodied.

FIG. 2D shows a state in which a mode of the user interface is converted back to the 4-way navigation key mode. In order to convert a mode of the user interface from the 8-way pointer mode back to the 4-way navigation key mode, a mode cancellation key 28 is pressed. The mode cancellation key 28 is a key in which a mode cancellation function is mapped to an existing function key. Accordingly, the mode cancellation key 28 can be mapped to any one of a soft key, end key, and cancellation key. If a mode of a user interface is converted to the 4-way navigation key mode, the pointer 26 disappears and the focus 23 appears at the same position as the pointer 26.

In another method of converting back to a 4-way navigation key mode while using the mode cancellation key 28, if the pointer 26 is not used within a preset time duration in an 8-way search key mode, the 8-way search key mode is converted back to the 4-way navigation key mode.

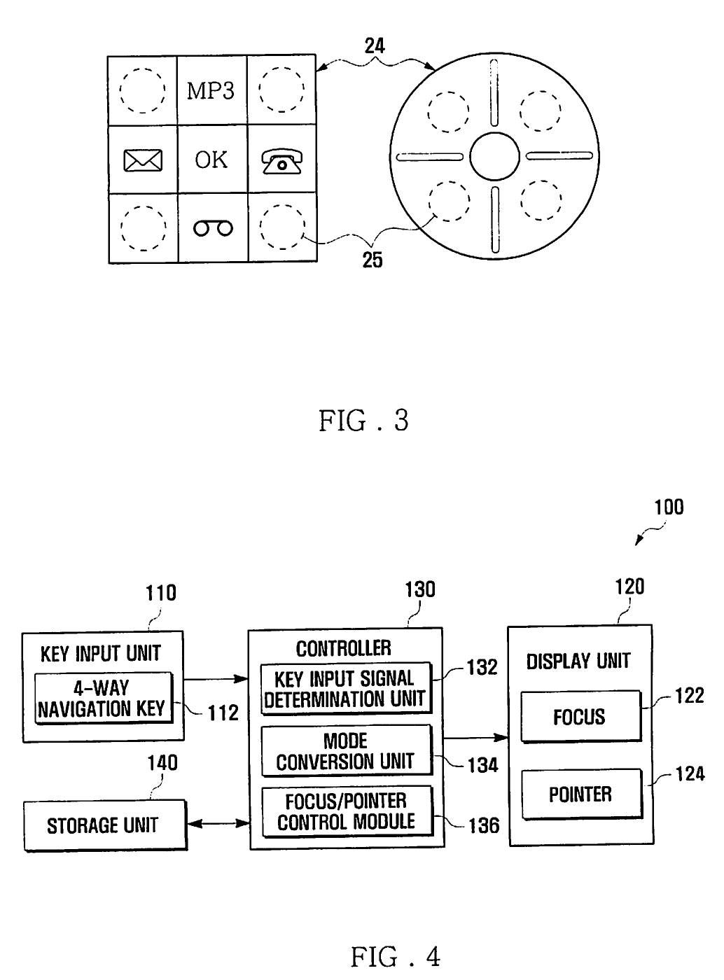

FIG. 4 shows a mobile terminal 100 for performing a method of converting a mode according to the present invention. The mobile terminal 100 includes a key input unit 110, display unit 120, controller 130, and storage unit 140. The mobile terminal 100 may be variously configured. For example, the mobile terminal 100 may be any of a personal information terminal, such as a mobile communication terminal, smart phone, Personal Digital Assistant (PDA), etc., a mobile broadcasting receiver, such as a Digital Multimedia Broadcasting (DMB) receiver, a multimedia player, such as an MP3 player, a Portable Multimedia Player (PMP), etc., or another mobile electronic appliance having a key input unit and a display unit.

The key input unit 110 generates an input signal according to a user's manipulation and outputs the input signal to the controller 130. The key input unit 110 includes a 4-way navigation key 112, and further includes various function keys, character keys, and numeric keys. The 4-way navigation key 112 includes four keys (for example, 24a to 24d of FIG. 2B) comprising an upper key, lower key, left key, and right key, and a press detection sensor (not shown) is provided in each key. A mode cancellation function can be mapped to any of the function keys, character keys, and numeric keys.

The display unit 120 visually displays various information related to a state and operation of the mobile terminal 100 by the control of the controller 130. In particular, the display unit 120 displays one of a focus 122 and a pointer 124 according to a mode of the user interface. The display unit 120 may use a Liquid Crystal Display (LCD) or other display devices, such as an Active Matrix Organic Light Emitting Diode (AM OLED) display or the like.

The controller 130 is a microprocessor for controlling general operations of the mobile terminal 100. In particular, the controller 130 includes a key input signal determination unit 132, mode conversion unit 134, and focus/pointer control module 136. The key input signal determination unit 132 receives an input signal from the key input unit 110 and identifies the input signal. For example, if a key input signal is received from the 4-way navigation key 112, the key input signal determination unit 132 determines whether the received signal is a cross direction press signal or a corner direction press signal. The mode conversion unit 134 performs mode conversion between a 4-way navigation key mode and an 8-way pointer mode according to a mode conversion condition. The focus/pointer control module 136 activates and inactivates the focus 122 and the pointer 124 and controls movement thereof according to an input signal of the 4-way navigation key 112.

The storage unit 140 is at least one memory element for storing various programs and data executed and processed in the mobile terminal 100. For example, the storage unit 140 stores a program necessary for driving the mode conversion unit 134 and the focus/pointer control module 136 and data related to the program.

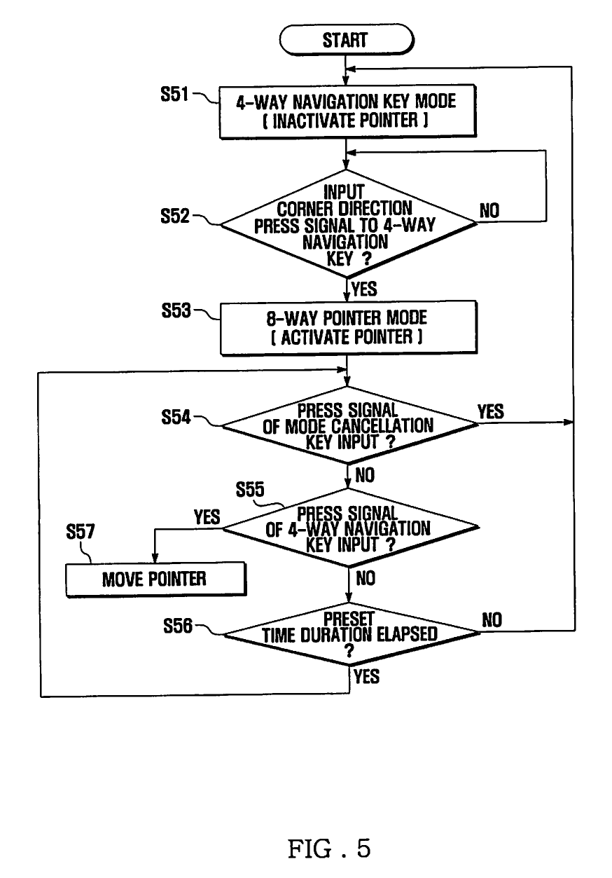

FIG. 5 shows a method of converting a mode of a user interface according to the present invention.

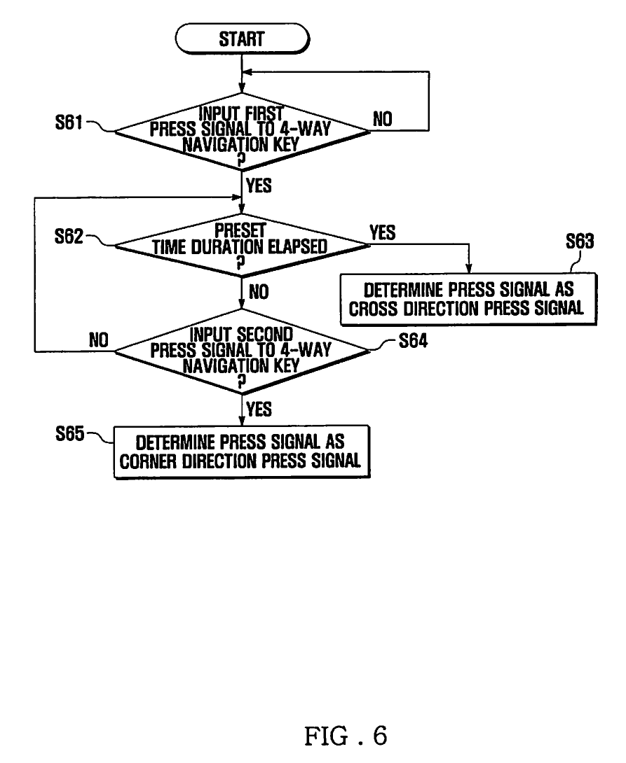

FIG. 6 shows a step of identifying an input of a search key press signal of the method of FIG. 5.

Referring to FIGS. 4 and 5, when a mode of the user interface is a 4-way navigation key mode, the focus/pointer control module 136 activates the focus 122, and inactivates the pointer 124 in step S51.

The key input signal determination unit 132 determines whether a corner direction press signal is input to the 4-way navigation key 112 in step S52. If a corner direction press signal is input to the 4-way navigation key 112, the key input signal determination unit 132 outputs the corner direction press signal to the mode conversion unit 134 and the focus/pointer control module 136.

A method of determining whether a press signal input to the 4-way navigation key 112 is a corner direction press signal or a cross direction press signal for performing step S52 is shown with reference to FIG. 6.

Referring to FIGS. 4 and 6, the key input signal determination unit 132 determines whether a first press signal is input to the 4-way navigation key 112 in step S61. When one of an upper key, lower key, left key, and right key of the 4-way navigation key 112 is pressed, the first press signal is an input signal generated by a press detection sensor detecting the pressed key.

After a first press signal is input to the 4-way navigation key 112 at step S61, the key input signal determination unit 132 determines whether a preset critical time duration (for example, 0.1 second) has elapsed after input of the first press signal in step S62. If a critical time duration has elapsed after input of the first press signal without a further signal input, the key input signal determination unit 132 determines that the press signal is a cross direction press signal in step S63. That is, if another key is not pressed within the critical time duration after one of an upper key, lower key, left key, and right key of the 4-way navigation key 112 is pressed, the signal is determined to be a press signal of the corresponding cross direction.

If a critical time duration has not elapsed after input of the first press signal at step S62, the key input signal determination unit 132 determines whether a second press signal is input to the 4-way navigation key 112 in step S64. The second press signal is an input signal generated by a sensor adjacent to the press detection sensor generating the first press signal. If a second press signal is input, that is, if an adjacent key is pressed within a critical time duration after one of an upper key, lower key, left key, and right key of the 4-way navigation key 112 is pressed, the key input signal determination unit 132 determines that the press signal is a corner direction press signal corresponding to a border of two keys in step S65.

If a second press signal is not input to the 4-way navigation key 112 at step S64, the process returns to step S62 and the key input signal determination unit 132 again determines whether the preset critical time duration has elapsed.

The second press signal input by a key adjacent to the key of the first press signal is determined to be a corner direction press signal for the following reason.

In an existing 4-way navigation key 112, press detection sensors are only provided in an upper key, lower key, left key, and right key. In order to detect key pressing of an upper left corner, upper right corner, lower left corner, and lower right corner as well as key pressing of an upper key, lower key, left key, and right key using the existing press detection sensors, a determination is made whether a press signal is input from each of two adjacent press detection sensors within a critical time duration. When a corner of the 4-way navigation key 112 is pressed, two adjacent keys are sequentially pressed with a very small time difference. Accordingly, a determination is made whether the signal is a corner direction press signal or a cross direction press signal by checking whether a press signal is input from each of two adjacent keys within a preset time duration.

A method of identifying a press signal according to the present invention is not limited to the method of identifying a press signal of FIG. 6. FIG. 6 shows a method that can use an existing 4-way navigation key. If the 4-way navigation key 112 has press detection sensors in corners, the method of identifying a press signal of FIG. 6 may be replaced with another method.

Returning to FIGS. 4 and 5, if the corner direction press signal is output by the key input signal determination unit 132 at step S52, the mode conversion unit 134 converts the 4-way navigation key mode to an 8-way pointer mode, and the focus/pointer control module 136 inactivates the focus 122 and activates the pointer 124 in step S53.

After a mode of the 4-way navigation key mode is converted to the 8-way pointer mode, the key input signal determination unit 132 determines whether a press signal of a mode cancellation key is input in step S54. If a press signal of a mode cancellation key is input, the key input signal determination unit 132 outputs the press signal to the mode conversion unit 134 and the focus/pointer control module 136. Accordingly, the process returns to step S51, where the mode conversion unit 134 converts the 8-way pointer mode to the 4-way navigation key mode, and the focus/pointer control module 136 activates the focus 122 and inactivates the pointer 124.

If a press signal of a mode cancellation key is not input at step S54, the key input signal determination unit 132 determines whether a press signal of the 4-way navigation key 112 is input in step S55. If a press signal of the 4-way navigation key 112 is input, the focus/pointer control module 136 controls movement of the pointer 124 to the corresponding direction in step S57.

If a press signal of the 4-way navigation key 112 is not input at step S55, the key input signal determination unit 132 determines whether a preset time duration (for example, 3 seconds) has elapsed after converting to an 8-way pointer mode in step S56. If a preset time duration has elapsed without inputting a press signal of either the mode cancellation key or the 4-way navigation key 112, i.e. if the pointer is not used within a preset time duration, the process returns to step S51 and the mode conversion unit 134 converts the 8-way pointer mode to the 4-way navigation key mode.

If a preset time duration has not elapsed at step S56, the key input signal determination unit 132 repeats steps S54 to S56 of determining whether a press signal of either the mode cancellation key or the 4-way navigation key 112 is input before the preset time duration elapses.

Two methods of converting a mode of the user interface that has been converted to the 8-way pointer mode back to the 4-way navigation key mode exist. A first method of converting the 8-way pointer mode back to the 4-way navigation key mode by pressing a mode cancellation key is a forced conversion method, and a second method of converting, when a key press signal is not input within a preset time duration, the 8-way pointer mode back to the 4-way navigation key mode is an automatic conversion method. In the present invention, either of the two methods may be used.

As described above, according to the present invention, in a user interface of a mobile terminal, both a 4-way navigation key mode and an 8-way pointer mode can be used, and mode conversion can be simply performed.

A method of converting a mode according to the present invention can be performed without adding a separate key, and a user interface can be effectively used. Particularly, a method of converting a 4-way navigation key mode to an 8-way pointer mode logically and intuitively corresponds to using the 8-way pointer mode.

Although preferred embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of converting a mode of a user interface of a mobile terminal having a 4-way navigation key, the method comprising:
determining whether a corner direction press signal of the 4-way navigation key is input in a 4-way navigation key mode; and
converting the 4-way navigation key mode to an 8-way pointer mode when a corner direction press signal of the 4-way navigation key is input in a 4-way navigation key mode.

2. The method of claim 1, further comprising determining whether a press signal of a mode cancellation key is input after converting the 4-way navigation key mode to the 8-way pointer mode; and
converting the 8-way pointer mode to the 4-way navigation key mode when a press signal of a mode cancellation key is input.

3. The method of claim 2, further comprising determining whether a press signal of the 4-way navigation key is input within a preset time duration after converting the 4-way navigation key mode to the 8-way pointer mode when a press signal of a mode cancellation key is not input; and
converting the 8-way pointer mode to the 4-way navigation key mode when a press signal of the 4-way navigation key is not input within a preset time duration.

4. The method of claim 1, further comprising determining whether a press signal of the 4-way navigation key is input within a preset time duration after converting the 4-way navigation key mode to the 8-way pointer mode; and
converting the 8-way pointer mode to the 4-way navigation key mode when a press signal of the 4-way navigation key is not input within a preset time duration.

5. The method of claim 1, wherein converting the 4-way navigation key mode to an 8-way pointer mode comprises activating a pointer for moving in eight directions.

6. The method of claim 2, wherein converting the 8-way pointer mode to the 4-way navigation key mode comprises inactivating a pointer for moving in eight directions.

7. The method of claim 3, wherein converting the 8-way pointer mode to the 4-way navigation key mode comprises inactivating a pointer for moving in eight directions.

8. The method of claim 4, wherein converting the 8-way pointer mode to the 4-way navigation key mode comprises inactivating a pointer for moving in eight directions.

9. A method of converting a mode of a user interface of a mobile terminal having a 4-way navigation key in which a press detection sensor is provided in each of an upward direction, downward direction, left direction, and right direction, the method comprising:
determining whether a press signal is input to each of two adjacent press detection sensors within a first preset time duration in a 4-way navigation key mode; and
converting the 4-way navigation key mode to an 8-way pointer mode when a press signal is input to each of two adjacent press detection sensors within a first preset time duration.

10. The method of claim 9, further comprising determining whether a press signal of a mode cancellation key is input after converting the 4-way navigation key mode to the 8-way pointer mode; and
converting the 8-way pointer mode to the 4-way navigation key mode when a press signal of a mode cancellation key is input.

11. The method of claim 10, further comprising determining whether a press signal is input to the press detection sensor within a second preset time duration after converting the 4-way navigation key mode to the 8-way pointer mode when a press signal of a mode cancellation key is not input; and
converting the 8-way pointer mode to the 4-way navigation key mode when a press signal is not input to any of the press detection sensors within a second preset time duration.

12. The method of claim 9, further comprising determining whether a press signal is input to any of the press detection sensors within a second preset time duration after converting the 4-way navigation key mode to the 8-way pointer mode; and
converting the 8-way pointer mode to the 4-way navigation key mode when a press signal is not input to any of the press detection sensors within a second preset time duration.

13. The method of claim 9, wherein converting the 4-way navigation key mode to an 8-way pointer mode comprises activating a pointer for moving in eight directions.

14. The method of claim 10, wherein converting the 8-way pointer mode to the 4-way navigation key mode comprises inactivating a pointer for moving in eight directions.

15. The method of claim 11, wherein converting the 8-way pointer mode to the 4-way navigation key mode comprises inactivating a pointer for moving in eight directions.

16. The method of claim 12, wherein converting the 8-way pointer mode to the 4-way navigation key mode comprises inactivating a pointer for moving in eight directions.
